(19) United States
(12) Patent Application Publication
(10) Pub. No.: US 2003/0024272 A1
(43) Pub. Date: Feb. 6, 2003

(54) Optical fiber drawing apparatus and control method therefor

(75) Inventors: Yasuhiro Naka, Tokyo (JP); Kazuhiro Kawano, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 10/108,456

(22) Filed: Mar. 29, 2002

(30) Foreign Application Priority Data
Aug. 3, 2001 (JP) 2001-236605

(51) Int. Cl. C03B 37/07

(52) U.S. Cl. 65/379; 65/381; 65/382; 65/486

(57) ABSTRACT

After the start of the control operation of a drawing apparatus, the operation control of a line speed being the drawing-in speed of an optical fiber is performed by a line speed control unit (19), and an optical-fiber feed speed control is performed by a preform feed speed control unit (22), in order that an optical fiber outside diameter measured by an optical-fiber outside diameter measurement unit (8) may become a target outside diameter. By way of example, in a case where the distal end of an optical fiber preform is not in a shape steadily melted in a heating furnace, the preform speed control unit (22) controls the feed speed of the optical fiber preform in the three stages of an optical-fiber-preform initial feed speed control, an acceleration-associated preform feed speed control and a line speed-associated preform feed speed control. In a case where the distal end of the optical fiber preform is in the steadily melted shape, the unit (22) controls the preform feed speed in two stages in which the acceleration-associated preform feed speed control is omitted from the three stages. In optical fiber drawing, troubles such as the breaking of the optical fiber can be suppressed even during the acceleration of the line speed.

### FIELD OF THE INVENTION

The present invention relates to an apparatus for drawing an optical fiber, and a method for controlling the apparatus.

### BACKGROUND OF THE INVENTION

An optical fiber (bare optical fiber) is prepared in such a way that an optical fiber preform is drawn to a set diameter while being heated, and that the drawn preform is cooled. An optical fiber strand is fabricated by applying a coating resin onto the outer peripheral side of the bare optical fiber.

### SUMMARY OF THE INVENTION

In one aspect, the present invention provides a control method for an optical fiber drawing apparatus as stated below.

In the optical fiber drawing apparatus to which the control method is applied having:

a heating furnace which serves to melt an optical fiber preform;

a preform feed unit which holds the optical fiber preform and feeds a distal end side of the optical fiber preform into the heating furnace;

a seal gas supply unit which introduces an inert gas into the heating furnace;

an optical-fiber outside diameter measurement unit which measures an outside diameter of an optical fiber heat-melted in the heating furnace and drawn;

a cooling unit which cools the drawn optical fiber by a cooling gas;

a resin coating unit which supplies a coating resin to the optical fiber cooled by the cooling unit, thereby to form the optical fiber with a resin coating;

a coating outside diameter measurement unit which measures an outside diameter of the optical fiber coated with the resin by the resin coating unit; and

an optical fiber drawing-in unit which draws in the optical fiber coated with the resin;

the control method for said optical fiber drawing apparatus, comprises the steps of:

performing an operation control of a line speed which is a drawing-in speed of said optical fiber after start of a control operation of said drawing apparatus, in order that the optical fiber outside diameter measured by said optical-fiber outside diameter measurement unit may become a target outside diameter; and

performing at least one control which is selected from the group consisting of controls (a)-(j);

(a) an optical fiber feed speed control in three stages as proceeds in a case where a distal end of the optical fiber preform is not in a shape steadily melted in said heating-furnace, and as is such that an optical-fiber-preform initial feed speed control which feeds said optical fiber preform by setting a feed speed of said optical fiber preform to be, at least, equal to a reference speed in a steady state, is performed since the start of the control operation of said drawing apparatus until a line acceleration being a drawing-in acceleration of said optical fiber arrives at a predetermined set line acceleration, or until the line speed arrives at a predetermined initial set line speed; that an acceleration-associated preform feed speed control which feedback-controls the feed speed of said optical fiber preform on the basis of a deviation between a detected acceleration and a pregiven target acceleration is performed since the line acceleration has arrived at the set line acceleration, or since said line speed has arrived at the initial set line speed, until said line speed arrives at a predetermined intermediate set line speed higher than said initial set line speed; and that a line speed-associated preform feed speed control which feedback-controls said feed speed of said optical fiber preform on the basis of a deviation between a detected line speed and a pregiven target line speed is performed after said line speed has arrived at the intermediate set line speed;

(b) an optical fiber feed speed control in two stages as proceeds in a case where the distal end of said optical fiber preform has already fallen into the shape melted in said heating furnace, and as is such that the optical-fiber-preform initial feed speed control is performed since said start of said control operation of said drawing apparatus until said line acceleration arrives at a predetermined set line acceleration or until said line speed arrives at a predetermined initial set line speed, and that the line speed-associated preform feed speed control is performed after said line acceleration has arrived at the set line acceleration or after said line speed has arrived at the initial set line speed;

(c) a washing control which washes a die of said resin coating unit to remove a residue of the coating resin and other dirts, before the coating of said optical fiber is started;

(d) a cooling-gas flow rate control which controls a flow rate of the cooling gas on the basis of a deviation between a predetermined target coating diameter and a coating outside diameter measurement value when the coating outside diameter measurement value measured by said coating outside diameter measurement unit has become, at most, the target coating diameter;

(e) a resin pressure control which controls a resin pressure to be supplied to the die, so as to become a predetermined value in association with said line speed;

(f) a seal-gas flow rate control which detects said line speed since start of an operation of said optical fiber drawing apparatus, which supplies the seal gas of a predetermined set flow rate into said heating furnace until the detected line speed arrives at a predetermined reference line speed for changing-over gas supply flow rates, and which controls a flow rate of said seal gas on the basis of predetermined control data for a line speed-associated seal-gas-supply flow rate after said detected line speed has arrived at the gas-supply-flow-rate changeover reference line speed;

(g) a heating-furnace temperature control which stores an internal optimum temperature of said heating furnace as an optimum furnace temperature every optical fiber drawing operation, so as to bring an internal temperature of said heating furnace to the optimum furnace temperature in a last drawing operation, at start of the acceleration of said line speed, and which measures an optical fiber tension so as to start controlling the temperature of said heating furnace at said line speed where discrepancy in the measured tensions has fallen into an allowable range permitting a precise tension measurement;

(h) a spin impressed control for which a spin impressed unit for imparting a torsion to said optical fiber is disposed, and which imparts the torsion to said optical fiber by the spin impressed unit after said line speed has arrived at said intermediate set line speed;

(i) at least either of:

a bobbin changeover control for which a bobbin changeover unit for taking up said optical fiber round at least two takeup bobbins continuously while changing-over the bobbins is disposed, which winds said optical fiber round the dummy bobbin for winding a non-conforming article, at the start of the drawing, and which changes the optical fiber winding bobbin over to the bobbin for a conforming article, subject to a bobbin changeover capability signal outputted after a feed length of said optical fiber preform has arrived at a predetermined set length; and

a monitor control for which a monitor unit for monitoring said optical fiber is disposed, which does not cause the monitor unit to monitor said optical fiber at said start of said drawing, and which causes said monitor unit to monitor said optical fiber, so as to store optical fiber quality information, after the changeover of said optical fiber winding bobbin to said bobbin for the conforming article; and

(j) a length store/clear control which stores a drawn length of said optical fiber and the feed length of said optical fiber preform, and which clears the stored drawn length and feed length in a case where one optical fiber preform has been entirely drawn.

Besides, in another aspect of the present invention, an optical fiber drawing apparatus as stated below is provided.

The optical fiber drawing apparatus comprises:

a heating furnace which serves to melt an optical fiber preform;

a preform feed unit which holds the optical fiber preform and feeds a distal end side of said optical fiber preform into said heating furnace;

a seal gas supply unit which introduces an inert gas into said heating furnace;

an optical-fiber outside diameter measurement unit which measures an outside diameter of an optical fiber heat-melted in said heating furnace and drawn;

a cooling unit which cools the drawn optical fiber by a cooling gas;

a resin coating unit which supplies a coating resin to the optical fiber cooled by said cooling unit, thereby to form said optical fiber with a resin coating;

a coating outside diameter measurement unit which measures an outside diameter of the optical fiber coated with said resin by said resin coating unit;

an optical fiber drawing-in unit which draws in said optical fiber coated with said resin;

a line speed control unit which performs an operation control of a line speed being a drawing-in speed of said optical fiber after start of a control operation of said drawing apparatus, in order that the optical fiber outside diameter measured by said optical-fiber outside diameter measurement unit may become a target outside diameter; and

at least one control unit which is selected from the group consisting of control units (o)-(x);

(o) a preform feed speed control unit which performs at least either of an optical fiber feed speed control in three stages and an optical fiber feed speed control in two stages;

wherein the former control in the three stages proceeds in a case where a distal end of the optical fiber preform is not in a shape steadily melted in said heating furnace, and it is such that an optical-fiber-preform initial feed speed control which feeds said optical fiber preform by setting a feed speed of said optical fiber preform to be, at least, equal to a reference speed in a steady state, is performed since the start of the control operation of said drawing apparatus until a line acceleration being a drawing-in acceleration of said optical fiber arrives at a predetermined set line acceleration, or until the line speed arrives at a predetermined initial set line speed; that an acceleration-associated preform feed speed control which feedback-controls the feed speed of said optical fiber preform on the basis of a deviation between a detected acceleration and a pregiven target acceleration is performed since the line acceleration has arrived at the set line acceleration, or since said line speed has arrived at the initial set line speed, until said line speed arrives at a predetermined intermediate set line speed higher than said initial set line speed; and that a line speed-associated preform feed speed control which feedback-controls said feed speed of said optical fiber preform on the basis of a deviation between a detected line speed and a pregiven target line speed is performed after said line speed has arrived at the intermediate set line speed; while the latter control in the two stages proceeds in a case where the distal end of said optical fiber preform has already fallen into the shape melted in said heating furnace, and it is such that the optical-fiber-preform initial feed speed control is performed since said start of said control operation of said drawing apparatus until said line acceleration arrives at a predetermined set line acceleration or until said line speed arrives at a predetermined initial set line speed, and that the line speed-associated preform feed speed control is performed after said line acceleration has arrived at the set line acceleration or after said line speed has arrived at the initial set line speed;

(p) a die washing control unit which performs a washing control for washing a die of said resin coating unit to remove a residue of the coating resin and other dirts, before the coating of said optical fiber is started;

(q) a cooling-gas flow rate control unit which controls a flow rate of the cooling gas on the basis of a deviation between a predetermined target coating diameter and a detected coating diameter when the coating outside diameter measurement value measured by said coating outside diameter measurement unit has become, at most, the target coating diameter;

(r) a resin pressure control unit which controls a resin pressure to be supplied to the die, so as to become a predetermined value in association with said line speed;

(s) a seal-gas flow rate control unit which detects said line speed since start of an operation of said optical fiber drawing apparatus, which supplies the seal gas of a predetermined set flow rate into said heating furnace until the detected line speed arrives at a predetermined reference line speed for changing-over gas supply flow rates, and which controls a flow rate of said seal gas on the basis of predetermined control data for a line speed-associated seal-gas-supply flow rate after said detected line speed has arrived at the gas-supply-flow-rate changeover reference line speed;

(t) a heating-furnace temperature control unit which stores an internal optimum temperature of said heating furnace as an optimum furnace temperature every optical fiber drawing operation, so as to bring an internal temperature of said heating furnace to the optimum furnace temperature in a last drawing operation, at start of the acceleration of said line speed, and which measures an optical fiber tension so as to start controlling the temperature of said heating furnace at said line speed where discrepancy in the measured tensions has fallen into an allowable range permitting a precise tension measurement;

(u) a spin impressed control unit which performs a spin impressed control for imparting a torsion to said optical fiber by a spin impressed unit that imparts the torsion to said optical fiber, after said line speed has arrived at said intermediate set line speed;

(v) a bobbin changeover control unit which winds said optical fiber round a dummy bobbin for winding a non-conforming article, at the start of the drawing, and which changes the optical fiber winding bobbin over to a bobbin for a conforming article, subject to a bobbin changeover capability signal outputted after a feed length of said optical fiber preform has arrived at a predetermined set length;

(w) a monitor control unit which does not cause an optical fiber monitoring unit to monitor said optical fiber at said start of said drawing, and which causes the optical fiber monitoring unit to monitor said optical fiber that is drawn in by said optical fiber drawing-in unit, so as to store optical fiber quality information, after the changeover of the optical fiber winding bobbin to the bobbin for the conforming article; and

(x) a length store/clear control unit which stores a drawn length of said optical fiber and the feed length of said optical fiber preform, and which clears the stored drawn length and feed length in a case where one optical fiber preform has been entirely drawn.

### BRIEF DESCRIPTION OF THE DRAWINGS

Exemplary embodiments of the invention will now be described in conjunction with drawings in which:

FIG. 1 is a block diagram of essential portions showing a controlling constructional example of an embodiment of an optical fiber drawing apparatus according to the present invention;

FIG. 2 is an explanatory view showing a constructional example of an optical fiber drawing apparatus;

FIG. 3 is a graph showing time series data examples of the line speed of optical fiber drawing and the feed speed of an optical fiber preform; and

FIG. 4 is a graph showing time series data examples of various controls in the optical fiber drawing operation.

### DETAILED DESCRIPTION

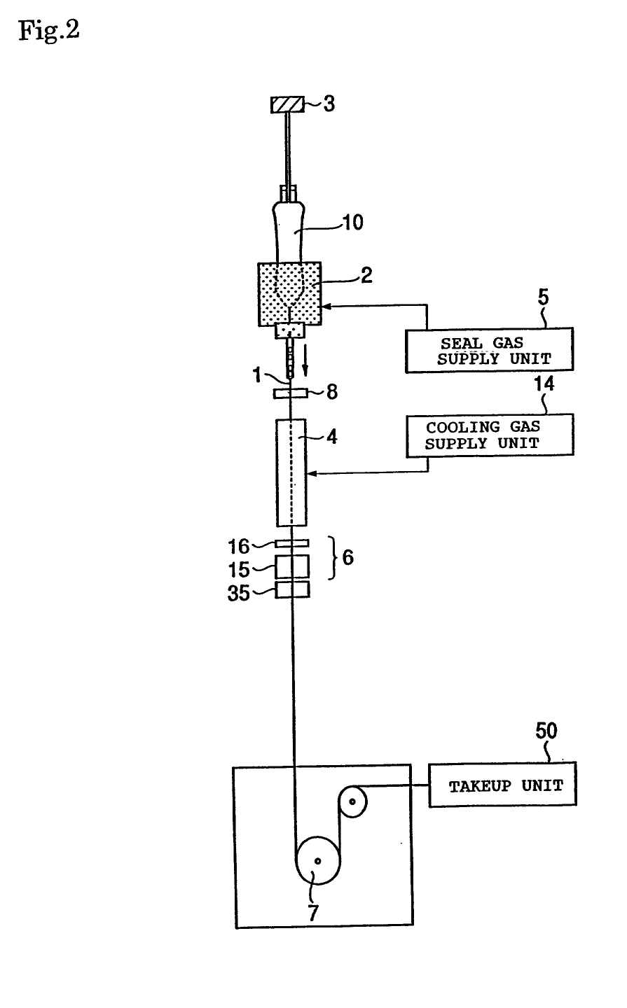

FIG. 2 is a conceptual view showing an example of an optical fiber drawing apparatus in a state where an optical fiber preform 10 is set. The optical fiber drawing apparatus includes a heating furnace 2 which serves to melt the optical fiber preform 10, and a preform feed unit 3 which holds the optical fiber preform 10 and feeds the distal end side of this optical fiber preform 10 into the heating furnace 2. Connected to the heating furnace 2 is a seal gas supply unit 5 which introduces an inert gas thereinto.

Besides, the optical fiber drawing apparatus includes an optical-fiber outside diameter measurement unit 8, and a cooling unit 4. The optical-fiber outside diameter measurement unit 8 measures the outside diameter of an optical fiber 1 obtained by drawing the preform 10 heated and melted in the heating furnace 2. A cooling gas supply unit 14 is connected to the cooling unit 4. This cooling unit 4 cools the drawn optical fiber 1 by a cooling gas supplied from the cooling gas supply unit 14.

Further, the optical fiber drawing apparatus includes a resin coating unit 6, a coating outside diameter measurement unit 35, an optical fiber drawing-in unit 7 and an optical fiber takeup unit 50. The resin coating unit 6 supplies a coating resin to the optical fiber 1 cooled by the cooling unit 4, so as to coat this optical fiber with the resin. In this example, the coating unit 6 has a construction in which the coating resin is supplied from a coating die 16 to the optical fiber 1 and is hardened by irradiation with light from a light source 15, thereby to coat the optical fiber 1 with the resin. The coating outside diameter measurement unit 35 measures the outside diameter of the optical fiber 1 coated with the resin by the resin coating unit 6. The optical fiber drawing-in unit 7 draws in the optical fiber 1 coated with the resin.

Usually, the optical fiber drawing apparatus as explained above has a construction in which a speed (line speed) for drawing in the optical fiber 1 by the optical fiber drawing-in unit 7 is controlled so as to arrive at a predetermined target line speed. Besides, in accelerating the optical fiber 1 from the initial line speed toward the target line speed, a feed speed at which the distal end of the optical fiber preform 10 is fed into the heating furnace 2 is raised. Thus, while a quantity in which the optical fiber preform 10 is melted is being increased, the line speed is heightened by the optical fiber drawing-in unit 7.

Meanwhile, it has heretofore been common practice that, when various parameters, for example, the coating diameter of the optical fiber 1, have fallen into predetermined allowable ranges after the arrival at the target line speed, the optical fiber 1 is judged to be deliverable as a product (namely, to be a conforming article). In an accelerating time zone since the start of the drawing of the optical fiber 1 till the arrival at the target line speed, the automatic controls of the flow rate of the cooling gas for the optical fiber 1, the coating diameter of the optical fiber 1, etc. have not been performed for the reason that the optical fiber 1 manufactured during the time zone is not used as the product.

However, unless the cooling-gas flow rate for the optical fiber 1, etc. are appropriately controlled, troubles such as breaking take place, so that the controlled variables have been finely adjusted by man. The fine adjustments have required skill.

From one point of view, the present invention consists in providing an optical fiber drawing apparatus and a control method therefor in which various controlled variables such as the flow rate of a cooling gas can be automatically controlled even during the acceleration of a line speed, thereby to prevent breaking and the like troubles without resorting to the degree of skill of an operator.

Now, an embodiment according to the present invention will be described in conjunction with the drawings.

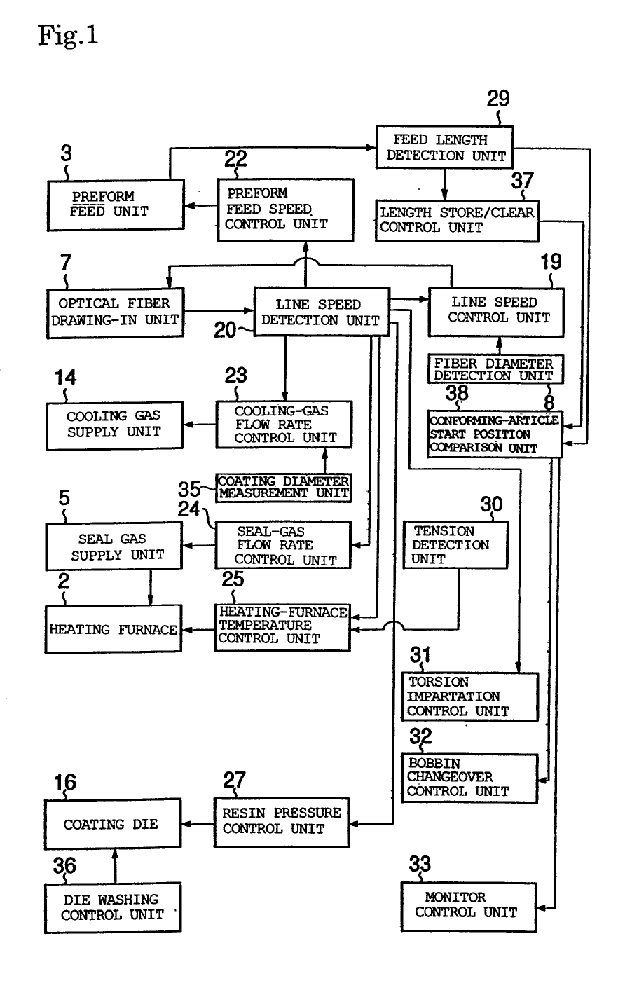

An optical fiber drawing apparatus in this embodiment has substantially the same apparatus construction as in FIG. 2. Referring to FIG. 1, a controlling constructional example of the optical fiber drawing apparatus of this embodiment is shown by a block diagram. By the way, in the description of this embodiment, the same reference numerals will be assigned to the same constituent portions as in the apparatus of FIG. 2, and the common portions shall not be repeatedly explained.

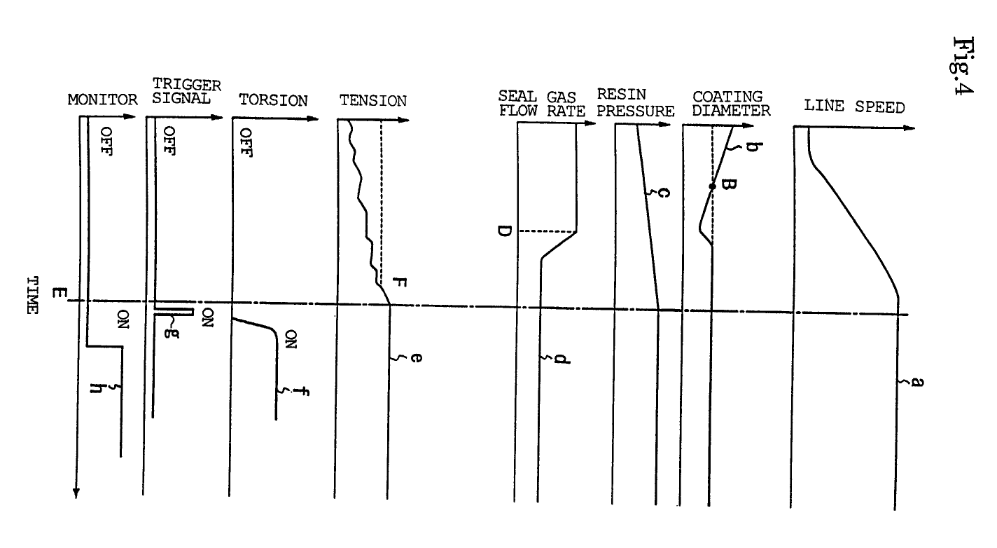

As shown in FIG. 1, the optical fiber drawing apparatus of this embodiment includes a line speed control unit 19. After the control operation of the drawing apparatus has been started, the line speed control unit 19 performs the operation control of a line speed so that the outside diameter of an optical fiber 1 as measured by an optical-fiber outside diameter measurement unit 8 may become a target outside diameter. Incidentally, an example of the time series data of the line speed is indicated at a line a in FIG. 4.

Besides, as shown in FIG. 1, the optical fiber drawing apparatus of this embodiment includes a line speed detection unit 20, a preform feed speed control unit 22, a cooling-gas flow rate control unit 23, a seal-gas flow rate control unit (furnace-seal-gas flow rate control unit) 24, a heating-furnace temperature control unit 25, a resin pressure control unit 27, a feed length detection unit 29, a tension detection unit 30, a spin impressed control unit 31, a bobbin changeover control unit 32, a monitor control unit 33, a die washing control unit 36, a length store/clear control unit 37, and a conforming-article start position comparison unit 38.

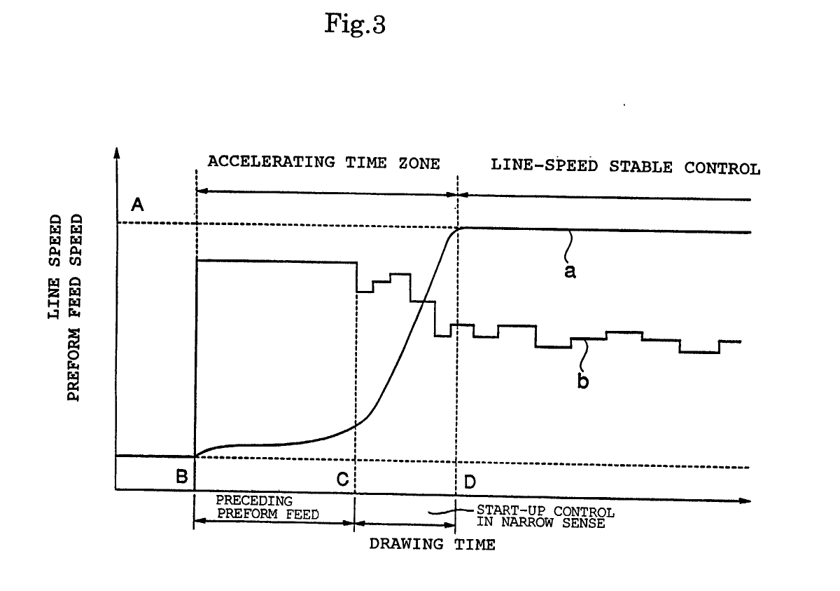

The preform feed speed control unit 22 has a construction which performs at least either of controls (a) and (b) stated below. By the way, in FIG. 3, an example of the time series data of the line speed of the optical fiber 1 is shown by a solid line a, while an example of the time series data of the feed speed of an optical fiber preform is shown by a solid line b.

The control (a) is performed in a case where the distal end of an optical fiber preform 10 is not yet in a shape steadily melted in a heating furnace 2. Here, the feed speed of the optical fiber 1 is controlled in the three stages of an optical-fiber-preform initial feed speed control, an acceleration-associated preform feed speed control and a line speed-associated preform feed speed control as explained below.

The optical-fiber-preform initial feed speed control is a control which is performed since the start of the control operation of the drawing apparatus until a line acceleration being the drawing-in acceleration of the optical fiber 1 arrives at a predetermined set line acceleration, or until the line speed arrives at a predetermined initial set line speed (for example, during an interval from a point B to a point C in FIG. 3). In this control, the optical fiber preform 10 is fed by setting the feed speed of the optical fiber preform 10 at a speed higher than a reference speed in a steady state (for example, at a speed which is at least 1.5 times higher than the steady-state speed).

Incidentally, the reference speed of the feed of the optical fiber preform 10 is based on a mass flow calculation. By way of example, letting PsO denote the reference speed of the optical fiber preform feed, Fs denote the target line speed of the optical fiber 1, Fd denote a target optical fiber diameter, and Pd denote an optical fiber preform diameter, the reference speed PsO of the optical fiber preform feed is given by Eq. (1):

PsO=Fs×(Fd/Pd)² (1)

Besides, in this embodiment, the initial set line speed is set within a range of 20% of the target line speed. However, the initial set line speed is not always set within this range, but it is appropriately set on occasion.

The acceleration-associated preform feed speed control is a control which is performed since the arrival of the line acceleration at the set line acceleration, or since the arrival of the line speed at the initial set line speed, until the line speed arrives at a predetermined intermediate set line speed higher than the initial set line speed (for example, during an interval from the point C to a point D in FIG. 3). In this control, the feed speed of the optical fiber preform 10 is feedback-controlled on the basis of the deviation between a detected acceleration and a pregiven target acceleration.

By the way, in this embodiment, the intermediate set line speed is set within a range of 90-100% of the target line speed. However, the intermediate set line speed is not always set within this range, but it is appropriately set on occasion.

The line speed-associated preform feed speed control is performed after the arrival of the line speed at the intermediate set line speed (for example, after the point D in FIG. 3). In this control, the feed speed of the optical fiber preform 10 is feedback-controlled on the basis of the deviation between a detected line speed and a pregiven target line speed.

Incidentally, the line speed is detected by the line speed detection unit 20, and the line acceleration is found by differentiating the detected line speed. Besides, in this embodiment, the target line speed is set at 1200 m/min, and the target line acceleration at 45 m/min². However, the target line speed and the target acceleration are appropriately set on the basis of various factors such as the apparatus construction, and their values are not especially restricted.

The control (b) is performed in a case where the distal end of the optical fiber preform 10 is already in a shape melted in the heating furnace 2. Here, the optical fiber feed is controlled in the two stages of the optical-fiber-preform initial feed speed control and the line speed-associated preform feed speed control. In this control, the optical-fiber-preform initial feed speed control is performed since the start of the control operation of the drawing apparatus until the line acceleration arrives at the predetermined set line acceleration, or until the line speed arrives at the predetermined initial set line speed. Besides, the line speed-associated preform feed speed control is performed after the arrival of the line acceleration at the set line acceleration, or after the arrival of the line speed at the initial set line speed.

In the case where the distal end of the optical fiber preform 10 is already in the shape melted in the heating furnace 2, the target line speed can be reached in a shorter time by applying the optical fiber feed control technique in the two stages of the optical-fiber-preform initial feed speed control and the line speed-associated preform feed speed control. That is, a drawing operation can be started up rapidly and stably.

Moreover, in this embodiment, when the detected line acceleration is greater than a reference acceleration in excess of an allowable range even by making the feed speed zero, the optical fiber preform 10 is pulled up (pulled up from the heating furnace 2) at a speed of, for example, about 3 mm/min.

In this embodiment, owing to the optical-fiber feed speed control as described above, the diameter of the optical fiber 1 can be precisely regulated, and the optical fiber 1 can be prevented from breaking during the acceleration of the line speed.

The die washing control unit 36 performs a washing control (c) stated below. The washing control (c) is the control of an operation in which, before the start of an optical fiber coating operation, the die (coating die) 16 of a resin coating unit 6 is washed to remove the residue of a coating resin and other dirts. Owing to the washing of the die 16, the optical fiber 1 can be restrained from undergoing bad influences such as the dirts.

The cooling-gas flow rate control unit 23 controls the flow rate of a cooling gas which is supplied from a cooling gas supply unit 14 to a cooling unit 4. Here, the control (d) is such that, when the measured value of a coating outside diameter measured by a coating outside diameter measurement unit 35 has become a predetermined target coating diameter or less (for example, when a value indicated by a characteristic curve b in FIG. 4 has become a value B or less), the flow rate of the cooling gas is controlled on the basis of the deviation between the target coating diameter and the detected coating diameter. Owing to the cooling-gas flow rate control (d), the coating outside diameter of the optical fiber 1 can be favorably controlled.

The resin pressure control unit 27 performs a control (e) in which the pressure of the resin to be supplied to the coating die 16 is controlled to a predetermined value in accordance with the line speed, for example, as indicated by a curve c in FIG. 4. Owing to the resin pressure control (e), the quantity of the coating resin which is supplied to the optical fiber 1 can be precisely controlled, and the resin can be restrained from overflow etc.

The seal-gas flow rate control unit 24 performs a seal-gas flow rate control (f). In this embodiment, by way of example, the seal-gas flow rate control unit 24 accepts a line speed value detected by the line speed detection unit 20, every moment since the start of the operation of the optical fiber drawing apparatus. Besides, until the detected line speed arrives at a predetermined reference line speed for the changeover of gas supply flow rates (for example, till a point D on a curve d in FIG. 4), the seal-gas flow rate control unit 24 supplies a predetermined set flow rate of seal gas into the heating furnace 2. Also, after the detected line speed has arrived at the gas supply flow rate changing-over reference line speed, the seal-gas flow rate control unit 24 controls the supply flow rate of the seal gas as indicated by the curve d in FIG. 4 by way of example, on the basis of pregiven data for a seal-gas-supply flow rate control associated with the line speed.

Incidentally, He (helium), Ar (argon) or a mixed gas consisting of them, for example, is generally employed as the seal gas. Besides, in case of employing the He gas of low density, the intrusion of the air is difficult of prevention immediately after the start of the drawing. Considering these facts, in this embodiment, the Ar gas is employed as the seal gas, and the flow rate thereof is set large (for example, at 8 liters/min).

Besides, when the drawing is proceeding at a high line speed, the seal gas is brought into a state where it is forced out of the exit of the heating furnace 2, and hence, any large flow rate of seal gas is unnecessary. Further, when the flow rate of the seal gas is too large, fluctuation in the diameter of the optical fiber 1 enlarges. In view of these facts, when the line speed has heightened to arrive at the gas supply flow rate changing-over reference line speed (for example, 600 m/min), the flow rate of the seal gas is decreased in units of 0.3 liter/min, and when the line speed has exceeded 1200 m/min, the flow rate of the seal gas is set at 3 liters/min.

In this embodiment, owing to such a seal-gas flow rate control, the intrusion of the air into the heating furnace 2 can be reliably prevented immediately after the start of the drawing. Besides, after the line speed has heightened, the diametral fluctuation of the optical fiber 1 is suppressed to prevent the breaking thereof, etc.

Incidentally, a seal gas supply unit 5 may well be so constructed that a plurality of lines for supplying the seal gas into the heating furnace 2 are formed beforehand, and that the lines for the seal gas are changed-over between at the stage which is immediately after the start of the drawing and at the stage at which the line speed has arrived at the gas supply flow rate changing-over reference line speed.

The tension detection unit 30 has a construction for measuring the tension of the optical fiber 1.

The heating-furnace temperature control unit 25 performs a temperature control (g) for the heating furnace 2. In this embodiment, the heating-furnace temperature control unit 25 stores the optimum internal temperature of the heating furnace 2 as the optimum furnace temperature each time the optical fiber drawing is carried out. Besides, at the start of the acceleration of the line speed, the heating-furnace temperature control unit 25 controls the internal temperature of the heating furnace 2 so that the internal temperature of the heating furnace 2 may become the optimum furnace temperature in the last drawing operation. Also, the heating-furnace temperature control unit 25 accepts the measured value of the optical fiber tension from the tension detection unit 30 every moment, and it controls the temperature of the heating furnace 2 in accordance with a pregiven control technique since discrepancy in the measured values has fallen into an allowable range to make the tension accurately measurable (for example, since a point F on a curve e in FIG. 4). Owing to the heating-furnace temperature control, the temperature of the heating furnace 2 can be precisely controlled to suppress the breaking of the optical fiber 1, etc.

The optical fiber drawing apparatus of this embodiment is furnished with a spin impressed unit (not shown). By way of example, the spin impressed unit has a construction in which the optical fiber 1 is held between rollers, and the rollers are reciprocally moved in directions substantially orthogonal to the running direction of the optical fiber 1 and in senses opposite to each other, thereby to impart a torsion to the optical fiber 1.

The spin impressed control unit 31 performs a control (h) for the operation of the spin impressed unit. In this embodiment, the spin impressed control unit 31 starts the operation of the spin impressed unit for imparting the torsion to the optical fiber 1, after the line speed has arrived at the intermediate set line speed by way of example and as indicated at f in FIG. 4 by way of example. Besides, the spin impressed control unit 31 reciprocates the rollers of the spin impressed unit at a predetermined set pitch in association with the line speed.

When the torsion is imparted in a state where the line speed is not sufficiently accelerated, the drawbacks of the breaking of the optical fiber 1, etc. occur. In contrast, in this embodiment, the occurrences of such drawbacks can be suppressed for the reason that the torsion is imparted to the optical fiber 1 after the arrival of the line speed at the target line speed.

This embodiment is furnished with a bobbin changeover unit (not shown) in which two or more takeup bobbins are changed-over to continuously take up the optical fiber 1. In this embodiment, at least two sorts of bobbins; a dummy bobbin and a bobbin for a conforming article are disposed as the takeup bobbins.

The conforming-article start position comparison unit 38 receives a current feed length detected by the feed length detection unit 29, through the length store/clear control unit 37 to be explained later, and it compares the received current feed length with a pregiven preform feed length capable of starting the conforming article, every moment. Besides, after the conforming-article start position comparison unit 38 has sensed the capability to start the conforming article, as the result of the comparison, it outputs a bobbin changeover capability signal.

The bobbin changeover control unit 32 performs a control (i) for the bobbin changeover unit. By way of example, in this embodiment, the bobbin changeover control unit 32 controls the bobbin changeover unit so that, at the start of the drawing operation, the optical fiber 1 maybe taken up by the dummy bobbin for winding a non-conforming article. Besides, the bobbin changeover control unit 32 causes the bobbin changeover unit to change the optical fiber winding bobbin over to the bobbin for the conforming article on condition that the bobbin changeover capability signal is outputted by the conforming-article start position comparison unit 38 (for example, that a trigger signal is turned ON as indicated by a signal g in FIG. 4) after the feed length of the optical fiber preform 10 detected by the feed length detection unit 29 has arrived at the predetermined set length.

Owing to the bobbin changeover control, the optical fiber can be continuously taken up with the non-conforming article and the conforming article distinguished. Therefore, the optical fiber 1 can be drawn by discarding only a defective part on the distal end side of the optical fiber preform 10 and without discarding a non-defective part, so that the optical fiber 1 can be efficiently taken up.

This embodiment is furnished with a monitor unit (not shown) which monitors the optical fiber 1.

The monitor control unit 33 does not cause the monitor unit to monitor the optical fiber 1 at the start of the drawing operation. After the bobbin for winding the optical fiber 1 has been changed-over to the bobbin for the conforming article, the monitor control unit 33 causes the monitor unit to monitor the optical fiber 1 which is taken up by the optical fiber takeup unit 50 as shown at h in FIG. 4 by way of example, and it stores optical fiber quality information. In this manner, the control (monitor control) for storing the optical fiber quality information is performed in combination with the bobbin changeover control (i).

Concretely, the monitor control unit 33 causes the monitor unit to monitor the hollow defect etc. of the optical fiber 1 in on-line fashion while the conforming article is being drawn. In the presence of any defect, the unit 33 stores the information thereof and later gives a command for cutting a defective part.

If the monitoring is begun immediately after the start of the drawing operation, wastefully any defect included in a non-conforming part is picked up. Especially in case of digital storage, the quantity of information to be stored should preferably be minimized because of the limited capacity of a storage medium. Accordingly, the optical fiber quality information is stored since the bobbin for winding the optical fiber 1 has been changed-over to the bobbin for the conforming article, whereby the optical fiber quality information can be stored promptly and precisely.

The length store/clear control unit 37 performs a control (j) stated below. By way of example, in the control (j), the drawn length of the optical fiber 1 and the feed length of the optical fiber preform 10 detected by the feed length detection unit 29 are stored every moment, and their values are applied to the conforming-article start position comparison unit 38. Besides, the length store/clear control unit 37 clears the stored drawn length and feed length in a case where one optical fiber preform 10 has been entirely drawn.

The optical fiber drawing apparatus of this embodiment is constructed as described above, and it automatically carries out the respective control operations by the corresponding control units. Thus, the optical fiber 1 can be drawn very efficiently irrespective of the degree of skill of an operator since the start of the optical fiber drawing operation. Moreover, troubles such as breaking can be prevented even before the line speed arrives at the target line speed. Also, the non-defective part of the optical fiber preform 10 need not be discarded.

Besides, this embodiment has a control construction in which, when the drawing has been interrupted midway of the optical fiber drawing operation, the optical fiber preform 10 is immediately pulled up from within the heating furnace 2. When the optical fiber preform 10 is left in the heating furnace 2 without being pulled up, it begins to melt and drops to incur the trouble of choking up the heating furnace 2. In contrast, in the case of pulling up the optical fiber preform 10 immediately upon the interruption of the drawing as in this embodiment, such a trouble can be prevented. It is thus permitted to properly cope with a case where, after the interruption of the drawing, the optical fiber preform 10 is melted again so as to draw the optical fiber 1.

Further, in this embodiment, the drawn length of the optical fiber 1 and the feed length of the optical fiber preform 10 are stored during the optical fiber drawing operation. In the case where, after the interruption of the drawing midway of the optical fiber drawing operation, the optical fiber preform 10 is melted again so as to draw the optical fiber 1, the length store/clear control unit 37 adds the drawn length of the optical fiber 1 and the feed length of the optical fiber preform 10 as measured in the current drawing operation, to the respectively corresponding values stored in the last drawing operation, and it stores the resulting sum values.

In this way, the case where one optical fiber preform 10 has been entirely drawn is clearly distinguished from the case where, after the interruption of the optical fiber drawing operation, the optical fiber preform 10 is melted again so as to draw the optical fiber 1, so that precise controls are permitted.

Incidentally, a control as stated below is performed in the case where, after the interruption of the optical fiber drawing operation, the optical fiber preform 10 is melted again so as to draw the optical fiber 1.

When the drawing has been interrupted midway of the optical fiber drawing operation, the internal temperature of the heating furnace 2 immediately before the interruption of the drawing is stored. Besides, when the optical fiber preform 10 is melted again so as to draw the optical fiber 1 after the interruption, the internal initial temperature of the heating furnace 2 is set at the temperature immediately before the interruption of the drawing.

Further, in this embodiment, in the case where the optical fiber preform 10 is melted again so as to draw the optical fiber 1 after the interruption of the drawing midway of the optical fiber drawing operation, the operation control of the line speed is performed so that the optical fiber outside diameter measured by the optical-fiber outside diameter measurement unit 8 may become a target outside diameter. The line acceleration is controlled as a limiter. By way of example, the maximum acceleration is set at 60 m/min/min.

Still further, in the case where the optical fiber preform 10 is melted again so as to draw the optical fiber 1 after the interruption of the drawing midway of the optical fiber drawing operation, a control (m) to be explained below is performed in addition to the line speed operation control, and at least one control is performed among at least either of the bobbin changeover control (i) and the monitor control, the washing control (c), the cooling-gas flow rate control (d), the resin pressure control (e), the seal-gas flow rate control (f), the heating-furnace temperature control (g) and the spin impressed control (h).

In the control (m), the optical-fiber-preform initial feed speed control is performed until the line acceleration arrives at the predetermined set line acceleration, or until the line speed arrives at the predetermined initial set line speed. Besides, the line speed-associated preform feed speed control is performed after the line acceleration has arrived at the set line acceleration, or after the line speed has arrived at the initial set line speed. In this manner, in the control (m), the optical fiber feed speed is controlled in the two stages of the optical-fiber-preform initial feed speed control and the line speed-associated preform feed speed control.

In this embodiment, in the case of interrupting the optical fiber drawing operation and then drawing the optical fiber 1 again, the above operations and controls are performed, whereby the optical fiber 1 can be precisely drawn even in the re-drawing mode, and the effects as explained before can be achieved. Besides, the optical fiber drawing operation can be efficiently performed by distinguishing the re-drawing mode from the case where one lot has been entirely drawn.

Incidentally, the present invention is not restricted to this embodiment, but it can take various aspects of performance. By way of example, in this embodiment, the control construction as shown in FIG. 1 is provided, and after the start of the control operation of the drawing apparatus, the operation control of the line speed is performed so that the optical fiber outside diameter measured by the optical-fiber outside diameter measurement unit 8 may become the target outside diameter, and besides, all the controls (a)-(j) are performed, but any construction suffices if it performs at least one of the controls (a)-(j). Also, an optical fiber drawing apparatus may be constructed by disposing at least one control unit in correspondence with the control to-be-performed.

According to the optical fiber drawing apparatus and the control method therefor in this embodiment, the feed speed of the optical fiber preform 10, etc. are controlled automatically and precisely even in the process of the acceleration of the line speed since the start of the drawing of the optical fiber 1. Therefore, the optical fiber 1 can be drawn very efficiently without resorting to the degree of skill of the operator, since the start of the drawing, and troubles such as the breaking of the optical fiber 1 can be suppressed before the line speed arrives at the target line speed.

What is claimed is:

1. In an optical fiber drawing apparatus having:
a heating furnace which serves to melt an optical fiber preform;
a preform feed unit which holds the optical fiber preform and feeds a distal end side of the optical fiber preform into the heating furnace;
a seal gas supply unit which introduces an inert gas into the heating furnace;
an optical-fiber outside diameter measurement unit which measures an outside diameter of an optical fiber heat-melted in the heating furnace and drawn;
a cooling unit which cools the drawn optical fiber by a cooling gas;
a resin coating unit which supplies a coating resin to the optical fiber cooled by the cooling unit, thereby to form the optical fiber with a resin coating;
a coating outside diameter measurement unit which measures an outside diameter of the optical fiber coated with the resin by the resin coating unit; and
an optical fiber drawing-in unit which draws in the optical fiber coated with the resin;
a control method for said optical fiber drawing apparatus, comprising the steps of:
performing an operation control of a line speed which is a drawing-in speed of said optical fiber after start of a control operation of said drawing apparatus, in order that the optical fiber outside diameter measured by said optical-fiber outside diameter measurement unit may become a target outside diameter; and
performing at least one control which is selected from the group consisting of controls (a)-(j);
(a) an optical fiber feed speed control in three stages as proceeds in a case where a distal end of the optical fiber preform is not in a shape steadily melted in said heating furnace, and as is such that an optical-fiber-preform initial feed speed control which feeds said optical fiber preform by setting a feed speed of said optical fiber preform to be, at least, equal to a reference speed in a steady state, is performed since the start of the control operation of said drawing apparatus until a line acceleration being a drawing-in acceleration of said optical fiber arrives at a predetermined set line acceleration, or until the line speed arrives at a predetermined initial set line speed; that an acceleration-associated preform feed speed control which feedback-controls the feed speed of said optical fiber preform on the basis of a deviation between a detected acceleration and a pregiven target acceleration is performed since the line acceleration has arrived at the set line acceleration, or since said line speed has arrived at the initial set line speed, until said line speed arrives at a predetermined intermediate set line speed higher than said initial set line speed; and that a line speed-associated preform feed speed control which feedback-controls said feed speed of said optical fiber preform on the basis of a deviation between a detected line speed and a pregiven target line speed is performed after said line speed has arrived at the intermediate set line speed;
(b) an optical fiber feed speed control in two stages as proceeds in a case where the distal end of said optical fiber preform has already fallen into the shape melted in said heating furnace, and as is such that the optical-fiber-preform initial feed speed control is performed since said start of said control operation of said drawing apparatus until said line acceleration arrives at a predetermined set line acceleration or until said line speed arrives at a predetermined initial set line speed, and that the line speed-associated preform feed speed control is performed after said line acceleration has arrived at the set line acceleration or after said line speed has arrived at the initial set line speed;
(c) a washing control which washes a die of said resin coating unit to remove a residue of the coating resin and other dirts, before the coating of said optical fiber is started;
(d) a cooling-gas flow rate control which controls a flow rate of the cooling gas on the basis of a deviation between a predetermined target coating diameter and a coating outside diameter measurement value when the coating outside diameter measurement value measured by said coating outside diameter measurement unit has become, at most, the target coating diameter;
(e) a resin pressure control which controls a resin pressure to be supplied to the die, so as to become a predetermined value in association with said line speed;
(f) a seal-gas flow rate control which detects said line speed since start of an operation of said optical fiber drawing apparatus, which supplies the seal gas of a predetermined set flow rate into said heating furnace until the detected line speed arrives at a predetermined reference line speed for changing-over gas supply flow rates, and which controls a flow rate of said seal gas on the basis of predetermined control data for a line speed-associated seal-gas-supply flow rate after said detected line speed has arrived at the gas-supply-flow-rate changeover reference line speed;
(g) a heating-furnace temperature control which stores an internal optimum temperature of said heating furnace as an optimum furnace temperature every optical fiber drawing operation, so as to bring an internal temperature of said heating furnace to the optimum furnace temperature in a last drawing operation, at start of the acceleration of said line speed, and which measures an optical fiber tension so as to start controlling the temperature of said heating furnace at said line speed where discrepancy in the measured tensions has fallen into an allowable range permitting a precise tension measurement;
(h) a spin impressed control for which a spin impressed unit for imparting a torsion to said optical fiber is disposed, and which imparts the torsion to said optical fiber by the spin impressed unit after said line speed has arrived at said intermediate set line speed;
(i) at least either of:
a bobbin changeover control for which a bobbin changeover unit for taking up said optical fiber round at least two takeup bobbins continuously while changing-over the bobbins is disposed, which winds said optical fiber round the dummy bobbin for winding a non-conforming article, at the start of the drawing, and which changes the optical fiber winding bobbin over to the bobbin for a conforming article, subject to a bobbin changeover capability signal outputted after a feed length of said optical fiber preform has arrived at a predetermined set length; and
a monitor control for which a monitor unit for monitoring said optical fiber is disposed, which does not cause the monitor unit to monitor said optical fiber at said start of said drawing, and which causes said monitor unit to monitor said optical fiber, so as to store optical fiber quality information, after the changeover of said optical fiber winding bobbin to said bobbin for the conforming article; and
(j) a length store/clear control which stores a drawn length of said optical fiber and the feed length of said optical fiber preform, and which clears the stored drawn length and feed length in a case where one optical fiber preform has been entirely drawn.

2. A control method for an optical fiber drawing apparatus according to claim 1, wherein:
the drawn length of said optical fiber and the feed length of said optical fiber preform are stored during an optical fiber drawing operation; and
when the drawing has been interrupted midway of the optical fiber drawing operation, said optical fiber preform is immediately pulled up from within said heating furnace.

3. A control method for an optical fiber drawing apparatus according to claim 1, wherein:
the drawn length of said optical fiber and the feed length of said optical fiber preform are stored during an optical fiber drawing operation; and
in a case where the drawing has been interrupted midway of the optical fiber drawing operation and where an optical fiber drawing operation is thereafter performed again by melting said optical fiber preform, the drawn length of said optical fiber and the feed length of said optical fiber preform as measured in performing the optical fiber drawing operation again are respectively added to values of said drawn length of said optical fiber and said feed length of said optical fiber preform as stored in the last operation, so as to store resulting sum values.

4. A control method for an optical fiber drawing apparatus according to claim 2, wherein:
the drawn length of said optical fiber and the feed length of said optical fiber preform are stored during an optical fiber drawing operation; and
in a case where the drawing has been interrupted midway of the optical fiber drawing operation and where an optical fiber drawing operation is thereafter performed again by melting said optical fiber preform, the drawn length of said optical fiber and the feed length of said optical fiber preform as measured in performing the optical fiber drawing operation again are respectively added to values of said drawn length of said optical fiber and said feed length of said optical fiber preform as stored in the last operation, so as to store resulting sum values.

5. A control method for an optical fiber drawing apparatus according to claim 1, wherein:
when the drawing has been interrupted midway of an optical fiber drawing operation, a temperature immediately before the interruption of the drawing is stored; and
in a case where an optical fiber drawing operation is performed again by melting said optical fiber preform after said interruption, an internal initial temperature of said heating furnace is brought to the stored temperature immediately before said interruption of said drawing.

6. A control method for an optical fiber drawing apparatus according to claim 2, wherein:
when the drawing has been interrupted midway of an optical fiber drawing operation, a temperature immediately before the interruption of the drawing is stored; and
in a case where an optical fiber drawing operation is performed again by melting said optical fiber preform after said interruption, an internal initial temperature of said heating furnace is brought to the stored temperature immediately before said interruption of said drawing.

7. A control method for an optical fiber drawing apparatus according to claim 4, wherein:
when the drawing has been interrupted midway of an optical fiber drawing operation, a temperature immediately before the interruption of the drawing is stored; and
in a case where an optical fiber drawing operation is performed again by melting said optical fiber preform after said interruption, an internal initial temperature of said heating furnace is brought to the stored temperature immediately before said interruption of said drawing.

8. A control method for an optical fiber drawing apparatus according to claim 1, wherein:
in a case where the drawing has been interrupted midway of an optical fiber drawing operation and where an optical fiber drawing operation is thereafter performed again by melting said optical fiber preform,
the operation control of the line speed is performed so that the optical fiber outside diameter measured by said optical-fiber outside diameter measurement unit may become the target outside diameter; and
at least one control selected from the group consisting of a control (m) and the controls (c)-(i) is performed;
wherein the control (m) is an optical fiber feed speed control in two stages as is such that an optical-fiber-preform initial feed speed control is performed until the line acceleration arrives at a predetermined set line acceleration or until said line speed arrives at a predetermined initial set line speed, and that a line speed-associated preform feed speed control is performed after said line acceleration has arrived at the set line acceleration or after said line speed has arrived at the initial set line speed.

9. A control method for an optical fiber drawing apparatus according to claim 2, wherein:
in a case where the drawing has been interrupted midway of an optical fiber drawing operation and where an optical fiber drawing operation is thereafter performed again by melting said optical fiber preform,
the operation control of the line speed is performed so that the optical fiber outside diameter measured by said optical-fiber outside diameter measurement unit may become the target outside diameter; and
at least one control selected from the group consisting of a control (m) and the controls (c)-(i) is performed;
wherein the control (m) is an optical fiber feed speed control in two stages as is such that an optical-fiber-preform initial feed speed control is performed until the line acceleration arrives at a predetermined set line acceleration or until said line speed arrives at a predetermined initial set line speed, and that a line speed-associated preform feed speed control is performed after said line acceleration has arrived at the set line acceleration or after said line speed has arrived at the initial set line speed.

10. A control method for an optical fiber drawing apparatus according to claim 4, wherein:
in a case where the drawing has been interrupted midway of an optical fiber drawing operation and where an optical fiber drawing operation is thereafter performed again by melting said optical fiber preform,
the operation control of the line speed is performed so that the optical fiber outside diameter measured by said optical-fiber outside diameter measurement unit may become the target outside diameter; and
at least one control selected from the group consisting of a control (m) and the controls (c)-(i) is performed;
wherein the control (m) is an optical fiber feed speed control in two stages as is such that an optical-fiber-preform initial feed speed control is performed until the line acceleration arrives at a predetermined set line acceleration or until said line speed arrives at a predetermined initial set line speed, and that a line speed-associated preform feed speed control is performed after said line acceleration has arrived at the set line acceleration or after said line speed has arrived at the initial set line speed.

11. A control method for an optical fiber drawing apparatus according to claim 7, wherein:
in a case where the drawing has been interrupted midway of an optical fiber drawing operation and where an optical fiber drawing operation is thereafter performed again by melting said optical fiber preform,
the operation control of the line speed is performed so that the optical fiber outside diameter measured by said optical-fiber outside diameter measurement unit may become the target outside diameter; and
at least one control selected from the group consisting of a control (m) and the controls (c)-(i) is performed;
wherein the control (m) is an optical fiber feed speed control in two stages as is such that an optical-fiber-preform initial feed speed control is performed until the line acceleration arrives at a predetermined set line acceleration or until said line speed arrives at a predetermined initial set line speed, and that a line speed-associated preform feed speed control is performed after said line acceleration has arrived at the set line acceleration or after said line speed has arrived at the initial set line speed.

12. An optical fiber drawing apparatus comprising:
a heating furnace which serves to melt an optical fiber preform;
a preform feed unit which holds the optical fiber preform and feeds a distal end side of said optical fiber preform into said heating furnace;
a seal gas supply unit which introduces an inert gas into said heating furnace;
an optical-fiber outside diameter measurement unit which measures an outside diameter of an optical fiber heat-melted in said heating furnace and drawn;
a cooling unit which cools the drawn optical fiber by a cooling gas;
a resin coating unit which supplies a coating resin to the optical fiber cooled by said cooling unit, thereby to form said optical fiber with a resin coating;
a coating outside diameter measurement unit which measures an outside diameter of the optical fiber coated with said resin by said resin coating unit;
an optical fiber drawing-in unit which draws in said optical fiber coated with said resin;
a line speed control unit which performs an operation control of a line speed being a drawing-in speed of said optical fiber after start of a control operation of said drawing apparatus, in order that the optical fiber outside diameter measured by said optical-fiber outside diameter measurement unit may become a target outside diameter; and
at least one control unit which is selected from the group consisting of control units (o)-(x);
(o) a preform feed speed control unit which performs at least either of an optical fiber feed speed control in three stages and an optical fiber feed speed control in two stages;
wherein the former control in the three stages proceeds in a case where a distal end of the optical fiber preform is not in a shape steadily melted in said heating furnace, and it is such that an optical-fiber-preform initial feed speed control which feeds said optical fiber preform by setting a feed speed of said optical fiber preform to be, at least, equal to a reference speed in a steady state, is performed since the start of the control operation of said drawing apparatus until a line acceleration being a drawing-in acceleration of said optical fiber arrives at a predetermined set line acceleration, or until the line speed arrives at a predetermined initial set line speed; that an acceleration-associated preform feed speed control which feedback-controls the feed speed of said optical fiber preform on the basis of a deviation between a detected acceleration and a pregiven target acceleration is performed since the line acceleration has arrived at the set line acceleration, or since said line speed has arrived at the initial set line speed, until said line speed arrives at a predetermined intermediate set line speed higher than said initial set line speed; and that a line speed-associated preform feed speed control which feedback-controls said feed speed of said optical fiber preform on the basis of a deviation between a detected line speed and a pregiven target line speed is performed after said line speed has arrived at the intermediate set line speed; while the latter control in the two stages proceeds in a case where the distal end of said optical fiber preform has already fallen into the shape melted in said heating furnace, and it is such that the optical-fiber-preform initial feed speed control is performed since said start of said control operation of said drawing apparatus until said line acceleration arrives at a predetermined set line acceleration or until said line speed arrives at a predetermined initial set line speed, and that the line speed-associated preform feed speed control is performed after said line acceleration has arrived at the set line acceleration or after said line speed has arrived at the initial set line speed;
(p) a die washing control unit which performs a washing control for washing a die of said resin coating unit to remove a residue of the coating resin and other dirts, before the coating of said optical fiber is started;
(q) a cooling-gas flow rate control unit which controls a flow rate of the cooling gas on the basis of a deviation between a predetermined target coating diameter and a detected coating diameter when the coating outside diameter measurement value measured by said coating outside diameter measurement unit has become, at most, the target coating diameter;
(r) a resin pressure control unit which controls a resin pressure to be supplied to the die, so as to become a predetermined value in association with said line speed;
(s) a seal-gas flow rate control unit which detects said line speed since start of an operation of said optical fiber drawing apparatus, which supplies the seal gas of a predetermined set flow rate into said heating furnace until the detected line speed arrives at a predetermined reference line speed for changing-over gas supply flow rates, and which controls a flow rate of said seal gas on the basis of predetermined control data for a line speed-associated seal-gas-supply flow rate after said detected line speed has arrived at the gas-supply-flow-rate changeover reference line speed;
(t) a heating-furnace temperature control unit which stores an internal optimum temperature of said heating furnace as an optimum furnace temperature every optical fiber drawing operation, so as to bring an internal temperature of said heating furnace to the optimum furnace temperature in a last drawing operation, at start of the acceleration of said line speed, and which measures an optical fiber tension so as to start controlling the temperature of said heating furnace at said line speed where discrepancy in the measured tensions has fallen into an allowable range permitting a precise tension measurement;
(u) a spin impressed control unit which performs a spin impressed control for imparting a torsion to said optical fiber by a spin impressed unit that imparts the torsion to said optical fiber, after said line speed has arrived at said intermediate set line speed;
(v) a bobbin changeover control unit which winds said optical fiber round a dummy bobbin for winding a non-conforming article, at the start of the drawing, and which changes the optical fiber winding bobbin over to a bobbin for a conforming article, subject to a bobbin changeover capability signal outputted after a feed length of said optical fiber preform has arrived at a predetermined set length;
(w) a monitor control unit which does not cause an optical fiber monitoring unit to monitor said optical fiber at said start of said drawing, and which causes the optical fiber monitoring unit to monitor said optical fiber that is drawn in by said optical fiber drawing-in unit, so as to store optical fiber quality information, after the changeover of the optical fiber winding bobbin to the bobbin for the conforming article; and
(x) a length store/clear control unit which stores a drawn length of said optical fiber and the feed length of said optical fiber preform, and which clears the stored drawn length and feed length in a case where one optical fiber preform has been entirely drawn.
